(19) United States
(12) Patent Application Publication
(10) Pub. No.: US 2015/0159532 A1
(43) Pub. Date: Jun. 11, 2015

(54) WEAR PLATE BETWEEN CANISTER AND ELECTRIC HEATING ELEMENTS

(71) Applicants: David J. Nicholls, Naperville, IL (US); Jeffrey Kelso, Fort Wayne, IN (US); Jason B. Arriaga, Wheaton, IL (US)

(72) Inventors: David J. Nicholls, Naperville, IL (US); Jeffrey Kelso, Fort Wayne, IN (US); Jason B. Arriaga, Wheaton, IL (US)

(73) Assignee: International Engine Intellectual Property Company , LLC, Lisle, IL (US)

(21) Appl. No.: 14/407,375

(22) PCT Filed: Jun. 11, 2012
(86) PCT No.: PCT/US12/41865

§ 371 Date: Dec. 11, 2014

(51) Int. Cl. F01N 3/20; H05B 3/48; H05B 3/06

(52) U.S. Cl. CPC F01N 3/2066; H05B 3/06; H05B 3/48; F01N 2610/02; F01N 2610/06; F01N 2610/1406; F01N 2610/10

(57) ABSTRACT

A heating device and method for use in heating a canister containing a reductant, such as ammonia for use in an after-treatment device in an exhaust system, is disclosed. The heating device or jacket includes two sections forming an interior chamber for receipt of the canister. The sections include multiple layers including an inner surface layer, which provides both uniform heating of the canisters positioned therein, and a wear plate for engaging the canister within the heating unit.

### TECHNICAL FIELD

The present device relates to the storage and delivery of a reductant for use in a NOₓ reduction system. Particularly, the device relates to a heating device or jacket having an inner surface as a conductive wear plate for engaging a canister containing an ammonia adsorbing/desorbing material capable of releasing gaseous ammonia for use in the selective catalytic reduction of NOₓ in an exhaust stream.

### BACKGROUND

Compression ignition engines provide advantages in fuel economy, but produce both NOₓ and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes is being employed in a growing number of systems.

One such system is the direct addition of ammonia to the exhaust stream in conjunction with an after-treatment device. It is an advantage to deliver ammonia directly in the form of a gas, both for simplicity of the flow control system and for efficient mixing of reducing agent, ammonia, with the exhaust gas. The direct use of ammonia also eliminates potential difficulties related to blocking of the dosing system, which are cause by precipitation or impurities, e.g., in a liquid-based urea solution. In addition, an aqueous urea solution cannot be dosed at a low engine load since the temperature of the exhaust line would be too low for complete conversion of urea to ammonia (and CO₂).

Transporting ammonia as a pressurized liquid, however, can be hazardous if the container bursts caused by an accident or if a valve or tube breaks. In the case of using a solid storage medium, the safety issues are much less critical since a small amount of heat is required to release the ammonia and the equilibrium pressure at room temperature can be—if a proper solid material is chosen—well below 1 bar. An ammonia adsorbing/desorbing material in a granular or powder form can be contained within disks or balls formed from aluminum and loaded into the cartridge or canister. The canisters are then positioned in a heating unit, such as a heating jacket, which is then loaded into a housing or other storage structure and secured to the vehicle for use. Appropriate heat is applied to the canisters, which then causes the ammonia-containing storage material to release its ammonia gas into an after-treatment device and the exhaust system, for example, of a vehicle. Therefore, regulating and maintaining the heat around the canisters is important for consistent and efficient release of ammonia into the exhaust stream, and more effective reduction of NOₓ. An efficient system requires that multiple canister system configurations be heated sequentially, with only one canister being actively heated at a time.

The present device offers heating unit or jacket having an inner surface layer that functions as both a heat conductive layer and a wear plate layer to provide uniform heating of the canisters, and long-term durability for engaging the canister.

### SUMMARY

There is disclosed herein a device and method, each of which avoids the disadvantages of prior devices, systems and methods while affording additional structural and operating advantages.

Generally speaking, the present device is a heating jacket having an inner surface for efficiently engaging the canisters containing the ammonia storage material, and providing uniform heating of the canister for effective release of ammonia into an exhaust after-treatment device on a vehicle.

In an embodiment, a heating unit for use in heating a canister containing an ammonia storage material, is disclosed. The unit comprises a first section having an inner surface, a second section having an inner surface, the second section detachably connected to the first section, wherein the first section inner surface and the second section inner surface together define a wear surface for engaging the canister and transferring heat around the canister.

In another embodiment, the first section and the second section each further comprise a plurality of layers, including a heating element layer, and insulation layer and an outer shell layer.

In another embodiment, the first section inner surface separates the canister from a heating element layer.

In yet another embodiment, the second section inner surface separates the canister from a heating element layer.

These and other aspects of the device and method may be understood more readily from the following description and the appended drawings.

### BRIEF DESCRIPTION OF THE DRAWINGS

FIG. 1 is a perspective view of present device, including several ASDS components;

FIG. 2 is a perspective front view of the present heating device;

FIG. 3 is a perspective rear view of the present heating device;

FIG. 4 is an exploded view of the present heating device; and,

FIG. 5 is a circuit diagram showing the temperature controller or thermistor.

### DETAILED DESCRIPTION

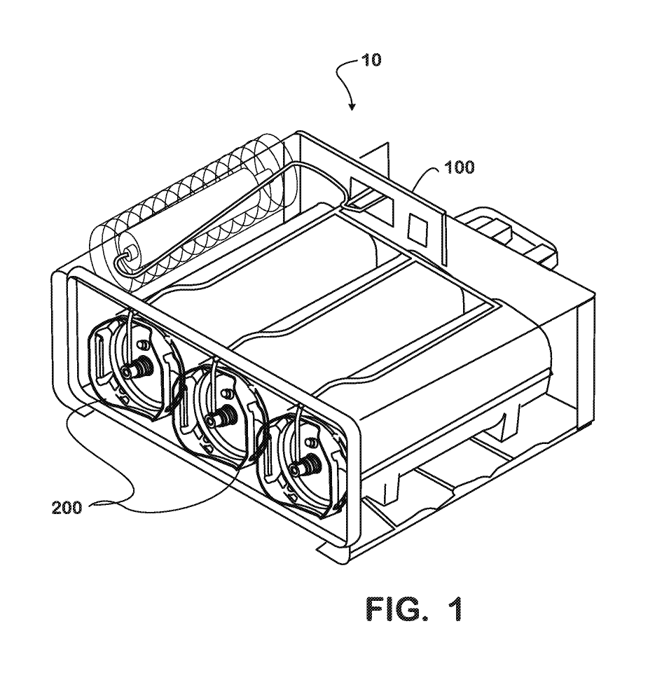

Referring to FIGS. 1-4, there is illustrated a heating device or jacket 10 for use in a system and method for storage and delivery of a reductant, such as ammonia, for use in the reduction of NOₓ in an exhaust stream. Ammonia storage and dosing systems (ASDS), which are part of the exhaust gas NOₓ reduction (EGNR) system used in vehicles, may be comprised of several components, including a start-up canister, at least one main canister contained within a housing or storage compartment, wherein the canisters contain an ammonia adsorbing/desorbing material, an ammonia control module (AFM), a peripheral interface module (PIM), and possibly other components depending on vehicle specifications. The specific components of the ASDS and EGNR will not be discussed in further detail with the exception of how it relates to the present unit. As the exhaust system of a vehicle, including that of a diesel engine, is well known, it will not be described in detail.

Referring to FIGS. 1-4, the heating jacket is generally designated by the numeral 10. The heating jacket 10 initiates and maintains an activation temperature for a main canister 200 or cartridge containing the ammonia adsorbing/desorbing material (not shown). The heating jacket 10 is positioned within a storage compartment or housing 100, which would then be attached to the frame of a vehicle (not shown) using any holder (not shown) permitting easy installation and removal of the jacket and its cartridges. The heating unit 10 may be designed to hold one or a plurality of canisters in a single unit. As well, the housing 100 for retaining the jackets and canisters may likewise be designed to hold one or a plurality of heating jackets. The housing 100 is typically a modular unit and can be arranged in various configurations on a vehicle.

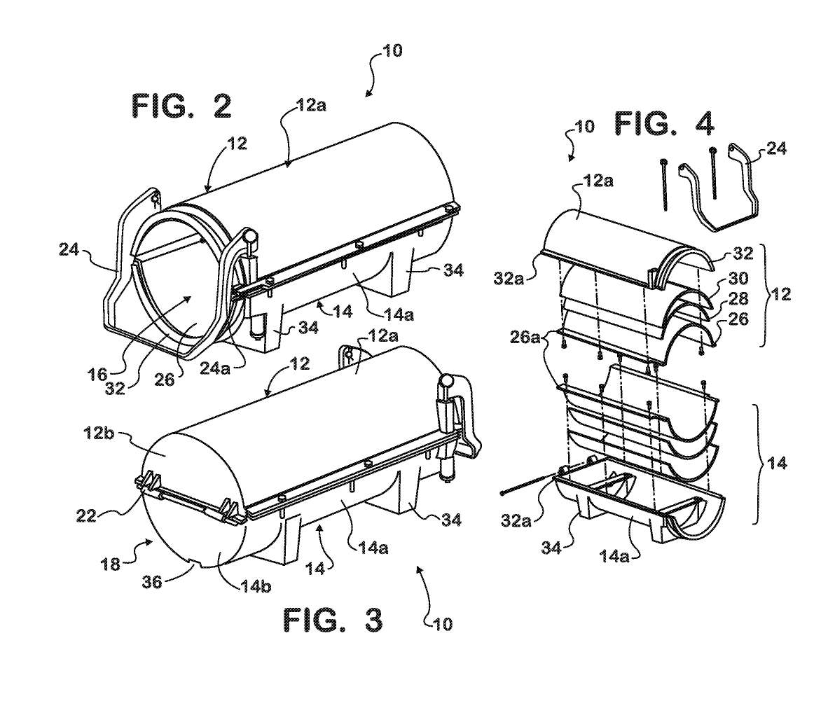

The heating jacket 10 is typically constructed of two symmetrical halves or sections, a first housing section 12 and a second housing section 14, each of which are comprised of a plurality of materials. Each section has a generally semi-circular shape. The sections 12, 14 are detachably connected together, or movably connected together to define an interior space or chamber 16 for receiving the canister 200. Specifically, as shown in FIG. 3, the sections 12, 14 each include opposing side walls 12a, and 14a, which form a portion of the interior space or chamber 16. Each section also includes an end wall or panel 12b, 14b, such that when the sections are joined together, the two end walls form a common closed rear wall 18 of the unit, as well as enclosing the chamber 16. Additionally, the joined sections 12, 14 form an opening 20 opposite the rear wall (FIG. 2) for receiving the canister within the chamber 16.

The two end walls 12b, 14b may be connected together through any suitable attachment means, permitting the two sections to move together or apart. For example, a hinge 22 or a plurality of hinges or other pivotal devices may be used to pivotally join the end panels together. In this manner, the sections 12, 14 are joined together at the rear wall 18, opening and closing as a clamshell. Because the sections 12, 14 are semi-cylindrical or symmetrical in shape, they are designed to fit securely together for receiving and centering the canister therein. Centering the canister within the interior chamber 16 of the heating jacket provides maximum heat conduction to the canister.

The heating jacket 10 may also include at least one support 34, for resting the jacket within the housing 100. In the embodiments shown in FIGS. 2-4, the supports 34 may be positioned on one of the front portion or the rear portion of the second section 14. Alternatively, there may be two supports, one of both the front and rear portion of the section. The support 34 or supports function to raise the jacket slightly off the floor of the housing 100, providing air circulation around the jacket. Alternatively, the support 34 may include an adjustment means, such as a screw, which can be rotated to lift the support and change the pitch of the heating jacket.

Heating and cooling of the heating unit 10 during use may result in an accumulation of condensation within the unit, and in particular between the layers of the sections if the layers are separately constructed rather than molded as a single sheet. Depending on the number of supports used and their location, the supports change the pitch angle of the jacket from a horizontal starting position to an angled position. Varying the pitch of the heating jacket aids in the drainage of any resulting condensation accumulating in the jacket, through a drain hole 36 (FIG. 3). The drain hole 36 may be located in the outer shell layer 34 in one section 12, 14, in both sections, or within other layers of the sections 12, 14. Coordinating the location of the drain hole 36 with the pitch of the heating jacket 10, specifically locating the opening on the downward end when the jacket is in the angled position, provides an effective system to drain excess moisture from the jacket.

The sections 12, 14 are designed to open completely away from one another for seating or removing a canister. The sections may be pivotally attached to one another at the end panels 12b, 14b to open and close as a clamshell. Alternatively, the sections may not be joined together, but rather the first section 12 can be lifted upwards completely detached from the second section 14 for insertion or removal of the canister. To aid in the opening of the unit in either manner, a handle 24 may be provided. In an embodiment, the handle 24 may also be configured for use in securing the canister within the jacket when the handle is in the downward position.

In conjunction with the handle 24, the two sections 12, 14 may be secured together using a tool-less locking mechanism. For example, as shown in FIG. 2, the handle 24 may be a pivotal lever or toggle lever, which is connected to a securing bolt 24a. The handle 24 is simply lifted upward without the need for any special tools, releasing the securing bolt 24a, and thus separating the two sections from one another. Once a canister is removed or loaded into the heating unit 10, the handle 24 can be pushed downward, wherein the securing bolt 24a locks the two sections together. Using this type of locking mechanism avoids the need for special tools or other devices.

Referring to FIG. 4, each half or section 12, 14 of the jacket is constructed from a plurality of layered materials. Specifically, the layers, typically in this order, include: an inner surface layer 26 constructed of a suitable heat conductive and durable material, such as aluminum; a heating element layer 28 constructed of a silicone encased resistive wire mesh; an insulation layer 30 constructed of any suitable insulation material such as foam or fiberglass; and an outer shell layer 32 constructed of any suitable durable material, such as a glass-filled polymer (nylon). The individual layers may be coextruded together, or optionally, the inner layer, heating element layer and insulation layer may be formed as a single sheet composite, which is then secured to the outer layer. For example and referring to FIG. 4, the inner layer 26 and the outer shell layer 32 each include a rim or edge 26a and 32a respectively, on either lateral side of the layer. Thus, the inner layer 26 is secured to the outer shell layer 32 through the respective edges 26a, 32a using known attachment means, such as bolts or screws, thereby creating the entire half or section of the jacket. The remaining layers, specifically the heating element layer 28 and the insulation layer 30, which may be slightly shorter in length and width than the outer shell layer 32 and the inner surface layer 26, are completely sealed between the secured outer shell layer and the inner surface layer.

It should be understood this is a representative example of the layered constructions of the present device, and that the number of layers and materials used therein, and the overall construction may vary according to the requirements of the application. However, it is advantageous to have the inner layer 26 forming the interior 16 of the unit, and because it directly engages the canister 200 and separates the canister from the heating element layer 28, it also serves as a conductive layer for uniform heating of the canister. Additionally, the inner layer 26 functions as a wear plate, wherein it frictionally engages with the canister when the canister is slid in and out of the heating jacket. Thus, it is useful that the inner surface wear plate is constructed from a durable material, which can withstand the sliding loading and unloading of the canisters, yet provide an effective conductive surface for heating the canister. The inner surface wear plate 26 also separates the canister, and frictional loading and unloading of the canister, from the heating element layer 28, which may have sensitive electrical components. The layered material sections forming the heating jacket insulate and direct the heat energy toward the ammonia-containing material stored within the canister, while isolating the heat source from the surrounding environment and its temperature influences. In this manner, the heating jacket 10 provides a consistent temperature and duration of heating to effectively release the ammonia gas from the ammonia adsorbing/desorbing material in the canisters for use in a NOₓ reduction system.

The ammonia adsorbing/desorbing material in the canisters is generally compressed powder or granules, which may be loaded into the canisters as aluminum disks or balls. The material may be formed using existing powder metal press technology. Regardless of the technology used to prepare the material, it is important to prevent the dissipation of ammonia during the formation of the material. Suitable material for use in the present application include metal-ammine salts, which offer a convenient storage medium for ammonia, and represent a safe, practical and compact option for storage and transportation of ammonia. Ammonia may be released from the metal ammine salt by heating the salt to temperatures in the range from 10° C. to the melting point to the metal ammine salt complex, for example, to a temperature from 30° to 700° C., and preferably to a temperature of from 100° to 500° C. Generally speaking, metal ammine salts useful in the present device include the general formula M(NH₃)ₙX_{z}, where M is one or more metal ions capable of binding ammonia, such as Li, Mg, Ca, Sr, V, Cr, Mn, Fe, Co, Ni, Cu, Zn, etc., n is the coordination number usually 2-12, and X is one or more anions, depending on the valence of M, where representative examples of X are F, Cl, Br, I, SO₄, MoO₄, PO₄, etc. Preferably, ammonia saturated strontium chloride, Sr(NH₃)Cl₂, is used. While embodiments using ammonia as the preferred reductant are disclosed, the invention is not limited to such embodiments, and other reductants may be utilized instead of, or in addition to, ammonia for carrying out the inventions disclosed and claimed herein. Examples of such other, or additional reductants include, but are not limited to, urea, ammonium carbamate, and hydrogen.

As noted, in order to effectively release ammonia gas from the ammonia adsorbing/desorbing material, the material must be heated to a specific temperature. Heating of the canister within the heating unit 10 may be accomplished using a heating element (not shown), such as a resistive element, which generates heat when an electrical current is passed through the element, or a conduit for a liquid, such as engine coolant. The heating element may be installed within the heating element layer 28 of the sections 12, 14. Although not shown, it should be understood that the heating element is connected to a power source (not shown) and control device, such as an electronic control module (not shown) to control the amount of heat generated by the heating jacket, as well as the duration of heating.

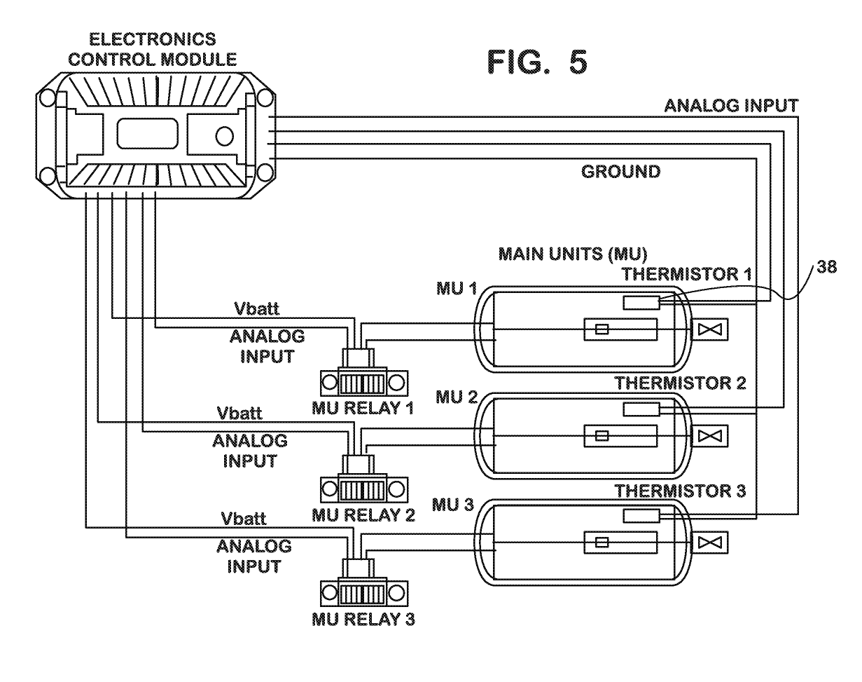

Regulating the temperature of the heating unit 10 is important to ensure the proper and consistent release of ammonia gas from the ammonia storage material contained within the canisters. In order to better regulate the temperature within the heating jacket 10, a controller 38 is included in the unit. The controller 38 is typically a temperature detection resistor or thermistor. FIG. 5 illustrates the circuitry involved in the ASDS system including the thermistor associated with each heating jacket. The controller 38 in the present system may be located in the circuitry outside of the heating jacket, or embedded within one of the layers of the heating jacket, for example, within the heating element layer 28. The heating jacket 10 may include a plurality of thermistors, in addition to pressure sensors (not shown) for sending appropriate signals to an electronic control module (not shown) for monitoring and controlling the heating element of the heating jacket, or even controlling the sequential heating of multiple jackets in the system. In this manner, the temperature applied to the canister can be controlled within predefined limits, such that it does not damage surrounding components or even the ammonia-containing material within the canisters.

What is claimed is:

1. A heating unit for use in heating a canister containing a reductant, the unit comprising:
a first housing section having an inner surface;
a second housing section having an inner surface, the second section detachably connected to the first section;
wherein the first housing section inner surface and the second housing section inner surface together define a wear surface for engaging the canister and transferring heat around the canister.

2. The heating unit of claim 1, wherein the first section further comprises a plurality of layers.

3. The heating unit of claim 2, wherein one of the layers comprises an outer shell layer.

4. The heating unit of claim 2, wherein one of the layers comprises an insulation layer.

5. The heating unit of claim 2, wherein one of the layers comprises a heating element layer.

6. The heating unit of claim 5, wherein the inner surface layer separates the canister from the heating element layer.

7. The heating unit of claim 1, wherein the second section further comprises a plurality of layers.

8. The heating unit of claim 7, wherein one of the layers comprises an outer shell layer.

9. The heating unit of claim 7, wherein one of the layers comprises an insulation layer.

10. The heating unit of claim 7, wherein one of the layers comprises a heating element layer.

11. A heating device for use in heating a canister containing an ammonia adsorbing/desorbing material, the unit comprising:
a first section having a inner surface wear plate, a heating element layer, an insulation layer and an outer shell layer;
a second section having a inner surface wear plate, a heating element layer, an insulation layer and an outer shell layer,
wherein the first section is detachably connected to the second section defining an interior chamber formed from the first section inner surface wear plate and the second section inner surface wear plate for slidably engaging the canister and transferring heat around the canister.

12. The heating device of claim 13, wherein the wear plates separate the canister from the heating element layer.
